(19) United States
(12) Patent Application Publication
(10) Pub. No.: US 2009/0218806 A1
(43) Pub. Date: Sep. 3, 2009

(54) Weldable pipe fitting

(76) Inventor: Daryl M. Piontek, Great Valley, NY (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 12/072,934

(22) Filed: Feb. 29, 2008

(51) Int. Cl. F16L 41/02

(52) U.S. Cl. 285/22

(57) ABSTRACT

A male fitting (15) comprising a fitting body (16) of a first material elongated along a longitudinal axis and having an outer surface (23, 27) and an inner surface (20) defining a through-passage (28), the outer surface having a first portion (23) and a shoulder (18) extending radially from the first portion, the shoulder being integral to the fitting body and formed substantially of the first material, the first portion of the outer surface adapted to engage a corresponding aperture (39) in a mating member (35), and the integral shoulder adapted to be heated into provide an autogenous weld (45) between the fitting body and the mating member.

### TECHNICAL FIELD

The present invention relates generally to the field of pipe fittings, and more particularly to an improved weldable male pipe outlet or connection.

### BACKGROUND ART

It is known in the prior art that male and female fittings may be welded to provide a fluid handling piping system connection. The male and/or female connections are tack welded on to the piping system to hold them in place prior to a conventional weld being applied between the fitting and the parent pipe, pipe coupling or other piping connection. A conventional weld is formed by heating and applying a separate weld filler along the seam between the two adjacent surfaces of the male and female pieces. The weld filler typically comes in wire form.

### DISCLOSURE OF THE INVENTION

With parenthetical reference to the corresponding parts, portions or surfaces of the disclosed embodiment, merely for the purposes of illustration and not by way of limitation, the present invention broadly provides an improved weldable male fitting (15) comprising a fitting body (16) of a first material elongated along a longitudinal axis and having an outer surface (23, 27) and an inner surface (20) defining a through-passage (28), the outer surface having a first portion (23) and a shoulder (18) extending radially from the first portion, the shoulder being integral to the fitting body and formed substantially of the first material, the first portion of the outer surface adapted to engage a corresponding aperture (39) in a mating member (35), and the integral shoulder adapted to be heated into provide an autogenous weld (45) between the fitting body and the mating member.

The first material may be stainless steel. The outer surface may be a generally cylindrical surface and the shoulder may be an annular ring extending from the cylindrical surface. The inner surface may be threaded. The fitting body may further comprise an annular end portion (21) and a tapered surface (22) extending between the annular end portion and the first portion the outer cylindrical surface. The annular shoulder may have an axial length (29) and a radial thickness (30) selected to provide a desired weld strength and filler material between the fitting body and the mating member. The shoulder may be dimensioned and positioned axially along the outer surface to provide a desired weld strength between the fitting body and the mating member. The mating member may be a pipe having a collared aperture and the fitting may provide a tap in the pipe.

The general object of the invention is to provide a fitting that may be more easily welded in place.

Another object is to provide a fitting which may be properly positioned in place for welding.

Another object is to provide a fitting that allows for the weld filler to be correctly located and provided in the correct amount for the desired strength of the weld.

Another object is to provide a fitting which can be welded with no undercut and which provides improved weld strength and quality.

Another object is to provide a fitting which may be welded without the need for externally added filler wire.

Another object is to provide a fitting which is easily aligned and inserted in place.

These and other objects and advantages will become apparent from the foregoing and ongoing written specification, the drawings and the appended claims.

### BRIEF DESCRIPTION OF THE DRAWINGS

FIG. 1 is a perspective view of the preferred embodiment of the fitting.

FIG. 2 is a longitudinal vertical sectional view of the fitting shown in FIG. 1, taken generally on line 2-2 of FIG. 1.

FIG. 3 is a perspective view of the preferred embodiment of a mating member having a socket or aperture adapted for engagement with the fitting shown in FIG. 1.

FIG. 4 is a perspective view of the fitting shown in FIG. 1 inserted into the corresponding aperture of the mating member shown in FIG. 3.

FIG. 5 is a perspective view of the fitting welded to the mating member shown in FIG. 3.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

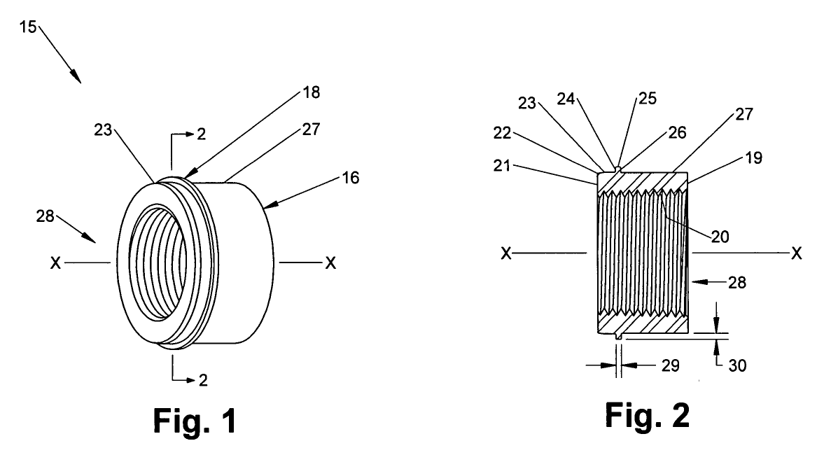

Referring now to the drawings, and more particularly to FIG. 1 thereof, this invention provides an improved male fitting, of which the presently preferred embodiment is generally indicated at 15. As shown in FIGS. 1-2, fitting 15 is generally a cylindrical ring-shaped annular structure elongated along axis x-x and bounded by a rightwardly-facing annular vertical surface 19, an inwardly-facing horizontal cylindrical surface 20, a leftwardly-facing annular vertical surface 21, an outwardly and leftwardly-facing annular frusto-conical surface 22, an outwardly-facing horizontal cylindrical surface 23, a leftwardly-facing annular vertical surface 24, an outwardly-facing horizontal cylindrical surface 25, a rightwardly-facing annular vertical surface 26, and an outwardly-facing horizontal cylindrical surface 27, joined at its right marginal end to the outer marginal end of surface 19.

Inner horizontal cylindrical surface 20 is a threaded surface and defines through-passage 28. Surfaces 24, 25 and 26 define shoulder 18, which extends radially from first portion 23 of the outer cylindrical surface of body 16 of fitting 15. Body 16 and shoulder 18 are formed of substantially the same material and shoulder 18 is integral to body 16 of fitting 15. In the preferred embodiment, fitting 15 is machined from stainless steel.

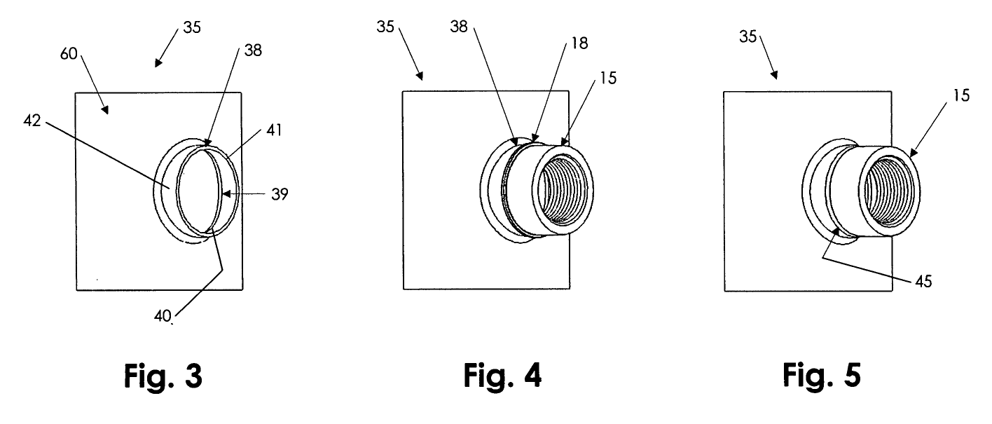

As shown in FIGS. 3-5, fitting 15 is adapted to be welded to a mating member 35. Because fitting 15 includes integrated shoulder 18, it is adapted to be heated and to provide the weld and weld filler material between fitting 15 and mating member 35 after the end of fitting 15 is inserted into a corresponding socket or aperture 39 in mating member 35. Shoulder 18 has an axial length 29 and a radial height 30 from outer surface 23 that is selected to provide the desired weld strength and filler material. The axial location of shoulder 18 along outer surface 23, 27 and the radial height 30 and axial width 29 can be selected so as to provide the desired weld filler material in the correct location and in the correct amount for autogeneously welding fitting 15 to collar 38 in mating member 35.

FIG. 3 shows an embodiment of a mating member with which fitting 15 may be used. In this embodiment, mating member 35 is the band 60 of the pipe repair clamp shown and described in U.S. Pat. No. 6,830,268 titled “Pipe Repair Clamp”, the entire disclosure which is incorporated herein by reference. However, in this embodiment, pipe repair clamp 35 is modified to include an aperture 39. As shown in FIG. 3, aperture 39 is formed by drawing out a collar 38 in band 60, the spinning of which increases the strength of stainless steel band 60. By welding fitting 15 to collar 38, heat is not applied directly to band 60, as heat is applied to only the end of collar 38 during welding.

Collar 38 is defined by an outwardly-facing horizontal cylindrical surface 42, a rightwardly-facing annular vertical surface 41 and an inwardly-facing horizontal cylindrical surface 40. Inner cylindrical surface 40 defines aperture 39 in member 35. As shown in FIG. 4, inner cylindrical surface 40 of member 35 and outer cylindrical surface 23 of fitting 15 are configured such that fitting 15 may be inserted into aperture 39 and held in place by the contact between adjacent concentric surfaces 40 and 23. The left end 21 of fitting 15 is provided with a taper 22 so that the end portion of fitting 15 will fit tightly in aperture 39 up to the left side 24 of shoulder 18.

Because of the close dimensioning of the outer cylindrical surface 23 and inner cylindrical surface 40 of fitting 15 and mating member 35, respectively, fitting 15 may be inserted and will remain in place without any tack welding. Tack welding is not needed to locate fitting 15 in proper finished welding position because shoulder 18 is configured to facilitate the proper positioning of fitting 15 relative to member 35 and the small tolerance between opposed surfaces 23 and 40 allow fitting 15 to be held in place without the need for such a tack weld. Fitting 15 is positioned properly when the leftwardly-facing vertical annular surface 24 of shoulder 18 abuts the rightwardly-facing vertical annular surface 41 of collar 38 in member 35. Because shoulder 18 is machined and is an integral part of fitting 15, it allows for fitting 15 to be properly located axially with respect to aperture 39 of mating member 35. Thus, even under conditions found at outdoor, underground or other non-optimal installation sites, fitting 15 can be easily positioned so as to provide the proper weld joint axis, proper weld material, the appropriate axial penetration depth of fitting 15 in aperture 39, the appropriate axial extension length of fitting 15 from aperture 39 for the desired assembly dimensional requirements. The axial thickness 29 and radial height 30 of shoulder 18 may be varied to accommodate varying material thicknesses, fitting diameters and optimal welding processes and strengths, as needed.

Once fitting 15 is placed in proper alignment in aperture 39 with the left annular vertical surface 24 of shoulder 18 contacting the rightwardly-facing annular vertical surface 41 of collar 38, heat is applied to shoulder 18 to autogeneously weld the two parts together. FIG. 5 shows the autogenous weld 45 between fitting 15 and member 35. In the prior art the weld would have been made with the application of separate weld filler wire between the adjacent surfaces of fitting 15 and member 35. With fitting 15, shoulder 18 is adapted to be heated and to provide the weld and weld filler material between the outer surface of fitting 15 and collar 38. Thus, in this embodiment fitting 15 is used to tap a band, pipe or tank.

While the presently-preferred form of the fitting has been shown and described, and several embodiments discussed, persons skilled in this art will readily appreciate that various additional changes and modifications may be made without departing from the spirit of the invention, as defined and differentiated by the following claims.

What is claimed is:

1. A weldable male fitting comprising:
a fitting body of a first material elongated along a longitudinal axis and having an outer surface and an inner surface defining a through-passage;
said outer surface having a first portion and a shoulder extending radially from said first portion;
said shoulder being integral to said fitting body and formed substantially of said first material;
said first portion of said outer surface adapted to engage a corresponding aperture in a mating member; and
said integral shoulder adapted to be heated and to provide an autogenous weld between said fitting body and said mating member.

2. The fitting set forth in claim 1, wherein said first material is stainless steel.

3. The fitting set forth in claim 1, wherein said outer surface is a generally cylindrical surface and said shoulder is an annular ring extending from said cylindrical surface.

4. The fitting set forth in claim 3, wherein said inner surface is a threaded cylindrical surface.

5. The fitting set forth in claim 3, wherein said fitting body further comprises an annular end portion and a tapered surface extending between said annular end portion and said first portion of said outer cylindrical surface.

6. The fitting set forth in claim 3, wherein said annular shoulder has an axial length and a radial thickness selected to provide a desired weld strength and filler material between said fitting body and said mating member.

7. The fitting set forth in claims 1, wherein said shoulder is dimensioned and positioned axially along said outer surface to provide a desired weld strength and filler material between said fitting body and said mating member.

8. The fitting set forth in claim 1, wherein said mating member is a pipe having a collared aperture and said fitting provides a tap in said pipe.
